(19) United States
(12) Patent Application Publication
(10) Pub. No.: US 2020/0189209 A1
(43) Pub. Date: Jun. 18, 2020

(54) COMPONENT MOUNTING ON STORAGE TANKS

(71) Applicant: SHAWCOR LTD., Rexdale (CA)

(72) Inventor: Babak Ahmadi Moghadam, Edmonton (CA)

(21) Appl. No.: 16/609,095

(22) PCT Filed: Feb. 2, 2018
(86) PCT No.: PCT/CA2018/050121

§ 371 Date: Oct. 28, 2019

Related U.S. Application Data
(60) Provisional application No. 62/504,665, filed on May 11, 2017.

(51) Int. Cl. B29C 65/00

(52) U.S. Cl. CPC B29C 66/71; B65D 90/022; B29C 66/721; B29C 66/1122

(57) ABSTRACT

A tank (e.g., an underground storage tank), and manufacturing methods therefore, may include a tank body having an exterior surface. A component is mounted on at least a non-planar portion of the exterior surface of the tank body using an adhesive (e.g., an MMA adhesive). For example, the component may be positioned on the non-planar portion of the exterior surface of the tank body after application of adhesive and pressure may be applied to maintain the position of the component on the non-planar portion of the exterior surface of the tank body as the adhesive is cured. The pressure may be removed upon curing of the adhesive and formation of a structural bond may occur at the adhesive interface between the mounting surface of the component and the non-planar portion of the exterior surface of the tank body.

This application claims the benefit of U.S. Provisional App. No. 62/504,665, filed May 11, 2017, the contents of which are incorporated herein by reference in their entirety.

### BACKGROUND

The present disclosure relates generally to storage tanks, and more particularly to the mounting of components, e.g., manway apparatus, collars, lift lugs, pipe fittings, etc., on such storage tanks (e.g., such as grind free mounting on fiber reinforced plastic (FRP, e.g., fiberglass reinforced plastic) underground storage tanks).

Underground storage tanks are used in a wide variety of locations to store materials underground. The stored materials may often be harmful to the environment. Examples of such materials may include gasoline and other petroleum products, e.g., oil and waste oil, as well as toxic raw materials and waste from manufacturing processes. Because of the possible harmful nature of many materials, it is especially important to ensure that underground storage tanks containing such materials do not leak or release these materials into the environment.

Concern over this possibility has led many governmental authorities to require secondary containment for tanks that store such materials, e.g., such as providing secondary containment through the use of double walled underground storage tanks. The assignee of the present application, ZCL Composites Inc., manufactures underground storage tanks prepared from corrosion resistant materials such as FRP (e.g., fiberglass reinforced plastic); which tanks have proven very reliable.

Fiber reinforced plastic is relatively light, can be prepared at the plant and shipped to the site, and is corrosion resistant. It is similarly unlikely to develop leaks. As such, underground storage tanks (e.g., double walled storage tanks), as well as above ground storage tanks, have been made using FRP to provide watertight and rustproof construction. For example, a FRP storage tank may be made on a male mold or mandrel, and once cured, at least preliminarily, removed from the mandrel. The process of manufacturing on a mandrel of this type is typically referred to as a “spray up” process, where fibers and plastic resin are applied over a release agent to the mandrel, which lends the storage tank its shape.

To provide a FRP storage tank, such as the storage tank shown in FIG. 1, with sufficient stiffness and strength to resist applied forces, and to resist deformation or buckling, ribs are used. Such ribs provide the molded product with hoop strength.

In a male molding process, the ribs may be provided by attaching a form to the molded cylindrical body, and then laying fiber up and across the form, providing the connection between the rib and the tank in the form of a secondary attachment. Processes for the manufacture of storage tanks of this type may be like those described, for example, in U.S. Pat. No. 3,925,132 entitled “Method of forming circumferentially extending ribs on a rotating shell” and issued 9 Dec. 1975.

FRP storage tanks have also been prepared from plastic resin and chopped fiber that is sprayed onto the interior of one or more female molds. The resin is preferably applied with a catalyst, as it is sprayed together with the chopped fiber, to create a strong, relatively stiff, water impermeable and corrosion resistant wall. The molds itself may include ribs where necessary, so that they become part of the integral structure. For example, processes of comminuting the glass fibers, as well as application of the fibers and resin to the interior of the female molds, may be like those described in U.S. Pat. No. 5,645,231 entitled “Glass choppers” and issued 8 Jul. 1997. After curing, the one or more female molds are removed for completion of the storage tank. For example, as described in U.S. Pat. No. 5,720,404 entitled “Female-molded underground storage tank and method of making” and issued 24 Feb. 1998, the storage tank may be made in two halves, which may then be married together by application of an additional fiberglass reinforced resin about a seam (e.g., two cylindrical shells terminating in dome shaped ends may be adjoined together at open ends of such cylindrical shells by FRP (using, for example, resin and fibers, resin and fiber mat, etc.) applied about a seam and at least on the exterior surface of the cylindrical shell adjacent the open ends).

Further, for example, openings for various components, such as fittings, manways, collars, monitoring reservoirs, and the like, may be introduced into the storage tank, as necessary, and such components may then be mounted on the storage tank at the defined locations. Yet still further, other useful components, such as lift lugs, guide lugs, etc. may also be mounted on the storage tank.

The mounting of such components on the FRP storage tank is generally accomplished by positioning the component on a prepared surface (e.g., a surface prepared by grinding for adhesion of FRP) and then using FRP to structurally attach the component to the FRP storage tank. For example, with respect to a cylindrical collar or a manway being attached to the exterior surface of a storage tank, a portion of the exterior surface adjacent to an opening formed for a collar or manway may be abraded by grinding. The collar or manway may then be positioned at the opening location and then the collar or manway may be secured to the storage tank with layers of FRP on both the inside and outside of the collar or manway and on tank surfaces adjacent thereto to structurally attach the collar or manway to the FRP storage tank.

Conventional structural attachment requires use of many layers of FRP, such as mat and/or woven roving and resin sufficient to structurally attach the component to the FRP storage tank. Generally, no less than 6.4 mm thickness of fiber or glass reinforcement layers impregnated with resin are sufficient to structurally attach components to the FRP storage tank. The laying up of such multiple layers in the process of attaching multiple components to an FRP storage tank significantly increases the cost of producing such a tank. Further, grinding of the tank surface to abrade the surface such that the components may be attached by laying up such multiple layers creates undesirable dust or particles in the manufacturing environment.

### SUMMARY

One or more embodiments of the present disclosure provide storage tanks (e.g., underground single wall storage tanks, double walled storage tanks, etc.) having one or more components mounted thereon, and methods of manufacturing such storage tanks, using adhesives to mount such components. In one or more embodiments, use of adhesives may reduce the amount of materials necessary for fabrication of one or more tanks. Further, in one or more embodiments, removable fabrics (e.g., peel ply) may be used to provide exterior surface portions of the storage tank with roughened surfaces reducing the amount of grinding necessary to prepare tank surfaces for mounting components, adjoining tank portions, etc. In one or more embodiments, reducing such grinding may protect the environment from undesirable FRP fragments, dust, and emission of styrene.

One exemplary embodiment of a method of manufacturing a storage tank (e.g., a fiberglass reinforced plastic storage tank) may include providing a tank body comprising an exterior surface formed of fiber reinforced plastic and providing a component to be mounted on at least a non-planar portion of the exterior surface of the tank body. The component includes a mounting surface configured to mate with at least the non-planar portion of the exterior surface of the tank body. The method may further include applying an adhesive to at least one of the mounting surface of the component and the non-planar portion of the exterior surface of the tank body, positioning the component on the non-planar portion of the exterior surface of the tank body, applying a pressure to maintain the position of the component on the non-planar portion of the exterior surface of the tank body as the adhesive is cured to form an adhesive interface between the mounting surface of the component and the non-planar portion of the exterior surface of the tank body; and removing the pressure upon curing of the adhesive and formation of a structural bond at the adhesive interface between the mounting surface of the component and the non-planar portion of the exterior surface of the tank body.

In one or more embodiments of the method, the component to be mounted may include at least one of a manway apparatus, a collar apparatus, and monitoring reservoir apparatus, and the component to be mounted may include a flange at a first end thereof (e.g., the flange may include the mounting surface about a perimeter of the first end). Further, for example, the non-planar portion of the exterior surface of the tank body may include a portion of at least one rib, and further the flange may include a mounting surface configured to mate with a portion of the at least one rib. Further, for example, in one or more embodiments, the flange may include a mounting surface formed such that a tolerance of mounting surface dimensions relative to corresponding dimensions of the non-planar portion of the exterior surface is within 80 mil.

In one or more other embodiments of the method, the component to be mounted may include at least one of a lift lug configured to be engaged by an apparatus used in lifting the tank body in at least a vertical direction, a guide lug configured to be engaged by an apparatus used in guiding the tank body in at least a horizontal direction, and a pipe fitting (e.g., the component may include a mounting surface configured to mate with at least the non-planar portion of the exterior surface of the tank body). For example, the component to be mounted may include a pipe fitting (e.g., the component includes an opening), wherein applying the pressure to maintain the position of the component on the non-planar portion of the exterior surface of the tank body as the adhesive is cured may include holding the component on the non-planar portion of the exterior surface of the tank body using a clamp comprising an elongate element extending through the opening of the pipe fitting. Further, for example, the mounting surface may be configured to mate with at least the non-planar portion of the exterior surface of the tank body and include a non-rectangular curved or bent mounting surface shape.

One or more embodiments of the method may include one or more of the following features: the component may be a component extending in a direction away from the exterior surface of the tank body; the component may include a portion that extends through at least the exterior surface of the tank body; the mounting surface of the component may include a roughened mounting surface upon which the adhesive is applied; the method may include cleaning the non-planar portion of the exterior surface to reduce any amount of lubricant thereon and positioning the component on the non-planar portion of the exterior surface thereafter without grinding or otherwise physically abrading the non-planar portion of the exterior surface; the method may further include heating the component to remove the component from the non-planar portion of the exterior surface of the tank body; the method may further include applying a protective material at one or more locations proximate the adhesive interface to prevent exposure of the adhesive interface to fluid; the method may further include applying one or more layers of FRP (e.g., resin and mat) material on a portion of the exterior surface adjacent the mounting surface of the component and continuously on a surface of the component opposite the mounting surface, wherein the one or more layers has a thickness of ⅛ inch (3.2 mm) or less; applying the pressure to maintain the position of the component on the non-planar portion of the exterior surface of the tank body as the adhesive is cured may include applying a pressure distribution evenly across the adhesive interface as the adhesive is cured; applying the adhesive may include using an ambient curing adhesive; applying the adhesive may include using an acrylic adhesive; applying the adhesive may include using an adhesive comprising methyl methacrylate (MMA); applying the adhesive may include using an adhesive comprising rigid particles having a diameter in the range of 30 mil to 80 mil; applying the adhesive may include using an adhesive having a thickness in the range of 30 mil to 80 mil after application of the pressure; applying the adhesive may include using an adhesive comprising rigid particles sized using a surfactant; applying the adhesive may include using an adhesive comprising micro- and/or nano-sized carbon particles; and the structural bond at the adhesive interface between the mounting surface of the component and the non-planar portion of the exterior surface of the tank body may be capable of withstanding 1240 kilopascals of peel stress applied thereto and, in addition or alternatively, 2712 Nm of bending moment applied thereto.

Further, in one or more embodiments of the method, providing the tank body may include providing a female mold portion having an interior surface to form at least a portion of the tank body, wherein the female mold portion comprises at least one of a cylindrical portion and a dome portion; adhering a removable fabric at one or more locations on the interior surface of the female mold portion corresponding to the non-planar portion of the exterior surface of the tank body; applying one or more layers of resin on the interior surface of female mold portion and over the removable fabric in formation of the exterior surface of the tank body; removing the at least a portion of the tank body from the female mold portion, wherein the removable fabric is removed with the at least a portion of the tank body when removed from the female mold portion; and removing the removable fabric from the exterior surface of the at least a portion of the tank body resulting in the non-planar portion of the exterior surface upon which the component is mounted being roughened as compared to other portions of the exterior surface of the tank body.

One or more exemplary embodiments of a storage tank (e.g., an fiberglass reinforced plastic storage tank, either underground or above ground) may include a tank body comprising an exterior surface formed of fiber reinforced plastic, a component mounted on at least a non-planar portion of the exterior surface (e.g., wherein the component may include a mounting surface configured to mate with at least the non-planar portion of the exterior surface of the tank body), and an adhesive at an adhesive interface between the mounting surface and the non-planar portion of the exterior surface of the tank body, the adhesive forming a structural bond at the adhesive interface between the mounting surface of the component and the non-planar portion of the exterior surface of the tank body.

In one or more embodiments of the storage tank, the component to be mounted may include at least one of a manway apparatus, a collar apparatus, and monitoring reservoir apparatus, wherein the component to be mounted may include a flange at a first end thereof (e.g., and further wherein the flange may include the mounting surface about a perimeter of the first end). Further, for example, the non-planar portion of the exterior surface of the tank body may include the portion of at least one rib, and further wherein the flange may include a mounting surface configured to mate with the portion of the at least one rib. Still further, for example, the flange may include a mounting surface formed such that a tolerance of mounting surface dimensions relative to corresponding dimensions of the non-planar portion of the exterior surface is within 80 mil.

In one or more embodiments of the storage tank, the component to be mounted may include at least one of a lift lug configured to be engaged by an apparatus used in lifting the tank body in at least a vertical direction, a guide lug configured to be engaged by an apparatus used in guiding the tank body in at least a horizontal direction, and a pipe fitting (e.g., wherein the component may include a mounting surface configured to mate with at least the non-planar portion of the exterior surface of the tank body). For example, the mounting surface configured to mate with at least the non-planar portion of the exterior surface of the tank body may include a non-rectangular curved or bent mounting surface shape.

One or more embodiments of the storage tank may include one or more of the following features: the component may be a component extending in a direction away from the exterior surface of the tank body; the component may include a portion that extends through at least the exterior surface of the tank body; the tank may further include a protective material at one or more locations proximate the adhesive interface to prevent exposure of the adhesive interface to fluid; the tank may further include one or more layers of FRP (e.g., resin and mat) material on a portion of the exterior surface adjacent the mounting surface of the component and continuously on a surface of the component opposite the mounting surface, wherein the one or more layers have a thickness of ⅛ inch or less; the adhesive may include an ambient curing adhesive; the adhesive may include an acrylic adhesive; the adhesive may include methyl methacrylate (MMA); the adhesive may include rigid particles having a diameter in the range of 30 mil to 80 mil; the adhesive may have a thickness in the range of 30 mil to 80 mil; the adhesive may include rigid particles sized using a surfactant; the adhesive may include micro- and/or nano-sized carbon particles; and the structural bond at the adhesive interface between the mounting surface of the component and the non-planar portion of the exterior surface of the tank body may be capable of withstanding 1240 kilopascals of peel stress applied thereto and, in addition or alternatively, 2712 Nm of bending moment applied thereto.

Further, one or more embodiments of a method of manufacturing a storage tank are described herein, wherein the method may include one or more of the following processes or features: providing a first female mold portion having an interior surface to form at least a first portion of a tank body having an exterior surface and a first open end (e.g., wherein the first female mold portion may include a first open end corresponding to the first open end of the first portion of the tank body, and further wherein the first female mold portion may include a first cylindrical portion being open on at least one end or a first dome portion being open on one end); providing a second female mold portion having an interior surface to form at least a second portion of the tank body having an exterior surface and having a second open end (e.g., wherein the second female mold portion may include a second open end corresponding to the second open end of the second portion of the tank body, and wherein the second female mold portion may include a second cylindrical portion being open on at least one end or a second dome portion being open on one end, and further wherein the first open end of the first portion of the tank body and the second open end of the second portion of the tank body may be configured to be adjoined by forming fiberglass reinforced plastic layers about a seam between perimeter portions of the exterior surfaces adjacent the first open end of the first portion of the tank body and the second open end of the second portion of the tank body); adhering a removable fabric along a perimeter at the first open end on the interior surface of the first female mold portion and along a perimeter at the second open end on the interior surface of the second female mold portion corresponding to the perimeter portions of the exterior surfaces adjacent the first open end of the first portion of the tank body and the second open end of the second portion of the tank body; applying at least one or more layers of resin on the interior surface of the first female mold portion and over the removable fabric in formation of the exterior surface of the first portion of the tank body; applying at least one or more layers of resin on the interior surface of the second female mold portion and over the removable fabric in formation of the exterior surface of the second portion of the tank body; removing the first portion of the tank body from the first female mold portion, wherein the removable fabric is removed with the first portion of the tank body when removed from the first female mold; removing the second portion of the tank body from the second female mold portion, wherein the removable fabric is removed with the second portion of the tank body when removed from the second female mold; removing the removable fabric from the exterior surface of the first portion of the tank body resulting in the perimeter portion of the exterior surface adjacent the first open end of the first portion of the tank body being roughened as compared to other portions of the exterior surface of the tank body; removing the removable fabric from the exterior surface of the second portion of the tank body resulting in the perimeter portion of the exterior surface adjacent the second open end of the second portion of the tank body being roughened as compared to other portions of the exterior surface of the tank body; and adjoining the exterior surfaces adjacent the first open end of the first portion of the tank body and the second open end of the second portion of the tank body by forming one or more fiberglass reinforced plastic layers around the roughened perimeter portions of the exterior surfaces adjacent the first open end of the first portion of the tank body and the second open end of the second portion of the tank body.

The above summary is not intended to describe each embodiment or every implementation of the present disclosure. Advantages, together with a more complete understanding of the disclosure, will become apparent and appreciated by referring to the following detailed description and claims taken in conjunction with the accompanying drawings.

### BRIEF DESCRIPTION OF THE DRAWINGS

FIG. 1 is an illustration of a conventional underground storage tank installation.

FIG. 2 is a perspective view of one exemplary embodiment of a storage tank including multiple components mounted on corresponding surfaces of the storage tank using an adhesive.

FIG. 3 is an exemplary block diagram of one or more embodiments of a method to mount one or more components on corresponding surfaces of a storage tank.

FIGS. 4A-4C show one exemplary embodiment of a manway apparatus mounted on an exterior surface of a storage tank, wherein; FIG. 4A is a perspective view;

FIG. 4B is a more detailed cross-sectional view of a portion thereof; and FIG. 4C is an enlarged view of a portion of FIG. 4B.

FIGS. 5A and 5B show a perspective view of one exemplary embodiment of a monitoring reservoir mounted on an exterior surface of a storage tank and a more detailed cross-sectional view of a portion thereof, respectively.

FIGS. 6A and 6B show a perspective view of one exemplary embodiment of a lift lug assembly mounted on an exterior surface of a storage tank and an exploded view thereof, respectively.

FIGS. 7A and 7B show a perspective view of one exemplary embodiment of a single pipe fitting mounted on an exterior surface of a storage tank and an exploded view thereof, respectively. FIGS. 7C and 7D show a top view and a side section view, respectively, of one exemplary embodiment of the single pipe fitting shown in FIGS. 7A and 7B.

FIG. 8 shows an exploded perspective view of one exemplary embodiment of a double pipe fitting to be mounted on an exterior surface of a storage tank.

FIG. 9 is an exemplary block diagram of one or more embodiments of a method which uses removable fabric to roughen surfaces for use in the formation of storage tanks.

FIGS. 10A-10F provide multiple diagrams for use in describing the method shown generally in FIG. 9, wherein: FIG. 10A shows the application of peel ply; FIG. 10B shows the layer of peel ply applied along a perimeter at an open end on an interior surface of a first (or second) female mold portion and at a second location; FIG. 10C shows application of one or more layers of FRP on the interior surface of the first (or second) female mold portion and over a removable fabric; FIG. 10D shows a portion of a tank body with the peel ply attached after separation from the first (or second) female mold portion; FIG. 10E shows the peel ply remaining on the portion of the tank body after removal from the female mold portion; and FIG. 10F shows the tank body after the peel ply is removed from the exterior surface of the portion of the tank body.

FIG. 11 provides a diagram for use in describing the method shown generally in FIG. 3.

The terms “FIG.” and “Figure” may be used interchangeably in reference to any particular figure.

### DETAILED DESCRIPTION OF EXEMPLARY EMBODIMENTS

In the following detailed description of illustrative embodiments of the present disclosure, reference is made to the accompanying figures of the drawing which form a part hereof, and in which are shown, by way of illustration, specific embodiments in which the disclosure may be practiced. It is to be understood that other embodiments may be utilized and structural changes may be made without departing from the scope of the present disclosure. Unless stated otherwise herein, the figures of the drawing are rendered primarily for clarity and thus may not be drawn to scale.

As used herein, “a,” “an,” “the,” “at least one,” and “one or more” are used interchangeably. The term “and/or” (if used) means one or all of the listed elements or a combination of any two or more of the listed elements. “I.e.” is used as an abbreviation for id est, and means “that is.” “E.g.,” is used as an abbreviation for exempli gratia, and means “for example.”

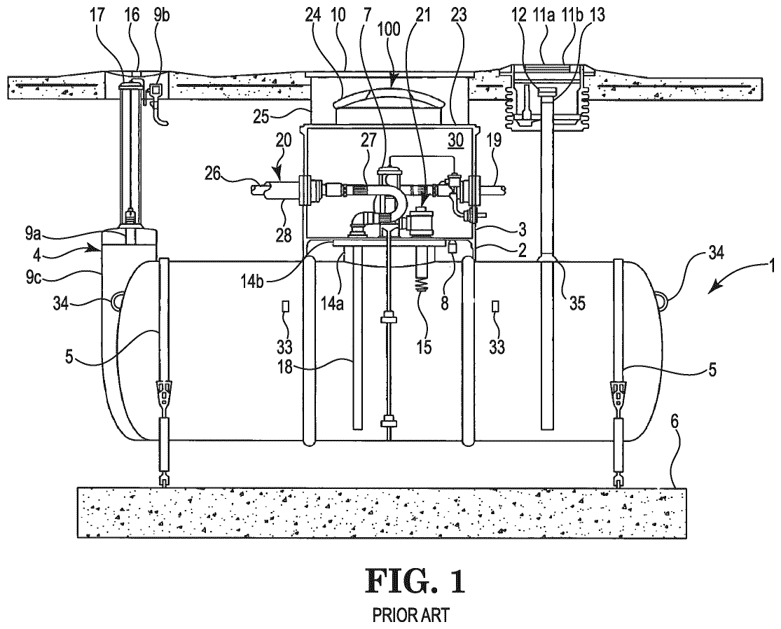

FIG. 1 is an illustration of a conventional underground storage tank installation, such as, for example, an underground storage tank 1 for containing petroleum. Although the present disclosure is primarily described with respect to underground storage tanks, the methods and/or tanks described herein, and/or the features thereof, may be utilized with any storage tank for containing any fluid (e.g., a fluid being a liquid and/or a vapor or gas). The present disclosure is not limited in any manner to only underground storage tanks for containing liquids, although some of the features described herein may be more beneficial to underground storage tanks for containing liquids.

The double walled underground storage tank (“UST”) 1 is secured by a pair of retaining straps 5 attached to a pair of deadmen 6 (one of which is visible in FIG. 1). The deadmen 6 may be of a conventional type or may be of the type described in U.S. Pat. No. 6,786,689, entitled “Low profile deadman and method for shipping the same with a tank” and issued on 7 Sep. 2004. As is known in the art, the straps 5 and deadmen 6 are sometimes necessary to prevent flotation of the UST 1 in the presence of a high water table. Other types of retaining systems, including above and below ground slabs, may also be used, along with components mountable on the UST 1 that may be operable with the retaining systems (e.g., guide channels for straps, hooks for attaching portions of a retaining system, etc.).

The double-walled UST 1 may include a hydrostatic monitoring system 4. The hydrostatic monitoring system may be used to monitor the level of a monitoring fluid, typically brine, between two walls of the double walled UST 1. The hydrostatic monitoring system 4 may include a monitoring sensor 9a for monitoring fluid in a monitoring reservoir 9c and connected to a communication module 9b through tube 17. The tube 17 may be accessible via a manhole 16. The hydrostatic monitoring system 4 may be used with a double walled UST 1 having a wet annulus. However, the present disclosure is not limited to USTs with wet annulus monitoring systems and may also be used with a UST having a dry annulus or an annulus that is slightly pressurized either negatively or positively.

The interior of the UST 1 may be filled from ground level by removing the cover 11a from the spill containment sump 11b, which provides access to the fill cap 12 covering the fill tube 13. The UST 1 includes a collar 2 to which is attached a riser 3. The collar 2 and riser 3 surround a manway 14a covered by a manway cover 14b. A riser cover 23 sits atop the riser 3. The riser cover 23 includes a removable domed cover 24. The collar 2, riser 3, riser cover 23 and domed cover 24 together form a watertight compartment that together form a sump 100. An access way 25 and ground level access way cover 10 provide access to the domed riser cover 24. The access way 25 and access way cover 10 are not part of the sump and are not necessarily water tight.

A level probe 7 is disposed within the sump 100 and passes through the manway cover 14b to monitor the level of fluid within the UST 1. A single walled vent pipe 19 is connected to the housing for the level probe 7 and passes through the wall of the riser 3 to provide venting for the UST 1. Also disposed within the sump 100 is an extractor assembly 21, which is connected through the manway cover 14b to ball float 15 in the interior of UST 1.

A double walled pipe 20 may carry gasoline to the UST 1. The double walled pipe 20 passes through a side of riser 3. The interior wall 26 of double walled pipe 20 is connected, via flex connector 27, to a pipe 18 passing through the manway cover 14b to the interior of the UST 1. The space between the outer wall 28 and inner wall 26 of double wall pipe 20 is in fluid communication with the sump 100. As discussed above, any fluid leaking from interior wall 26 of double wall pipe 20 will be contained by outer wall 28 and transported to sump 100 for containment. A sensor 8 detects any fluid in sump 100 and triggers an alarm system (not shown in FIG. 1).

Further, as shown in FIG. 1, the UST 1 may include other components attached thereto providing one or more various functions. For example, one or more lift lug assemblies 33 (e.g., for use in attaching lifting cables for lifting the tank as needed, for example, at least vertically such as with use of a crane) may be affixed to an exterior surface of the UST 1 using FRP, one or more guide lug assemblies 34 (e.g., for use in attaching guiding cables such that a user can guide or direct the tank in a horizontal direction as needed when being installed) may be affixed to an exterior surface of the UST 1, one or more pipe fittings 35 (e.g., for use in coupling pipes as needed to the tank) may be structurally affixed to an exterior surface of the UST 1, etc.

As shown by the conventional underground storage tank installation in FIG. 1, it should be recognized that various components require attachment to the various surfaces of a UST 1 to provide a useful product. The present disclosure provides one or more embodiments of storage tanks and methods of manufacturing such storage tanks, where adhesives are used to structurally bond one or more various components such as manifold apparatus, collars, monitoring reservoirs, pipe fittings, lift lug assemblies, guide lug assemblies, etc. to corresponding tank surfaces. Using such adhesives to form such structural bonding provides cost-effective tanks and methods of manufacturing such tanks.

Further, in one or more embodiments as described herein, various components of an FRP underground storage tank (e.g., shell sections, manway apparatus, collars, pipe fittings, lift lugs, guide channels, etc.) may be assembled and sealed by adhesives (e.g., such as MMA adhesives). The adhesives are used as structural elements, where the strength of the bonded elements and integrity of the entire tank rely on the strengths of the adhesive bond (e.g., the structural adhesive bond not being dependent upon any FRP layup, which may be provided for other purposes such as cosmetic or fluid barrier functionality). In one or more embodiments, the surfaces of the bonded components may be prepared to provide surface energies suitable for bonding using such adhesives. For example, the surface preparations may be different depending upon the materials of the components to be bonded (e.g., bonding of metal components such as carbon steel or stainless steel to FRP surfaces, bonding of FRP components to FRP surfaces, etc.). Further, thicknesses of the adhesive and the particular pattern of such adhesives applied on the bonding surfaces may also be different depending upon the materials of the components being bonded. Due to the engineered thickness of adhesives, such as MMA adhesives, which result in control toughness and flexibility of an adhesive joint, one or more of the bonded accessories can be loaded to certain amounts of deformation without any failure at different temperatures. Such designs using adhesives help to protect the integrity of the entire tank in the case of unexpected load applied to its components or accessories.

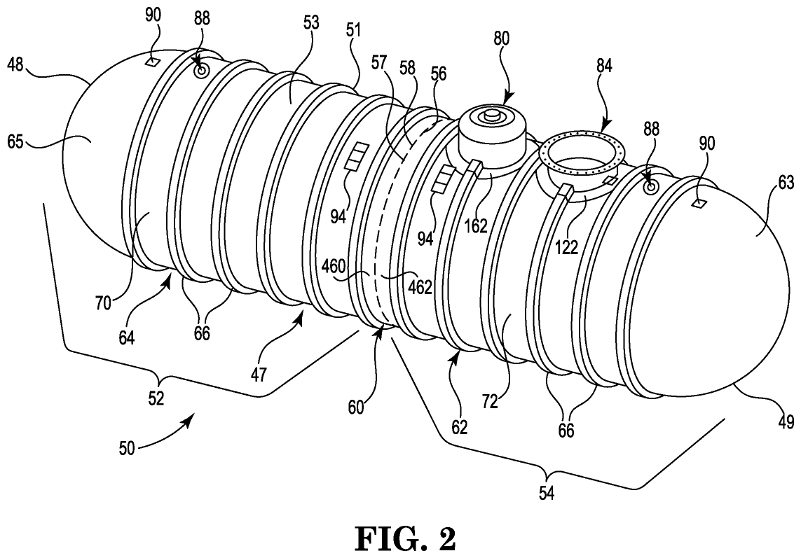

FIG. 2 shows a perspective view of one exemplary embodiment of an underground storage tank 50 according to the present disclosure. The underground storage tank 50 (e.g., a horizontally positioned storage tank) described herein may be formed of fiberglass reinforced plastic. However, the underground storage tank 50 may be formed of other materials such as one or more metals (e.g., steel), one or more polymers (e.g., polyethylene, polyvinyl chloride, polypropylene, polyurethane, and the like), or any other suitable storage tank material.

The underground storage tank 50 generally includes a tank body 47 including a cylindrical shell body 51 (e.g., a FRP cylindrical body) extending along a longitudinal axis from a first dome end 48 to a second dome end 49 defining an interior material holding volume. The underground storage tank 50 includes an exterior surface 53 which may include structure forming ribs 66 (e.g., circumferential ribs) between wall portions (e.g., circumferential smooth portions) where necessary.

The underground storage tank 50 may be manufactured as an integral unit or portions thereof may be produced separately and assembled (e.g., adjoined) using suitable materials (e.g., fiberglass lapping materials, such as resin and fiber containing mat and/or woven roving). In one or more embodiments, underground storage tank 50 may be produced using either male or female molding techniques. However, the present disclosure is not limited to any particular manufacturing technique for providing the tank body 47 including cylindrical shell body 51 and dome shaped ends 48, 49 which provides the exterior surface 53 of the underground storage tank 50 (e.g., the exterior surface 53 including various non-planar exterior surface portions upon which one or more components as described herein may be mounted using adhesive to provide a structural bond between such components and the exterior surface 53).

For example, in one or more embodiments, the underground storage tank 50 may be a male-molded underground storage tank, where the ribs may be attached to the outer surface of the cylindrical shell body 51.

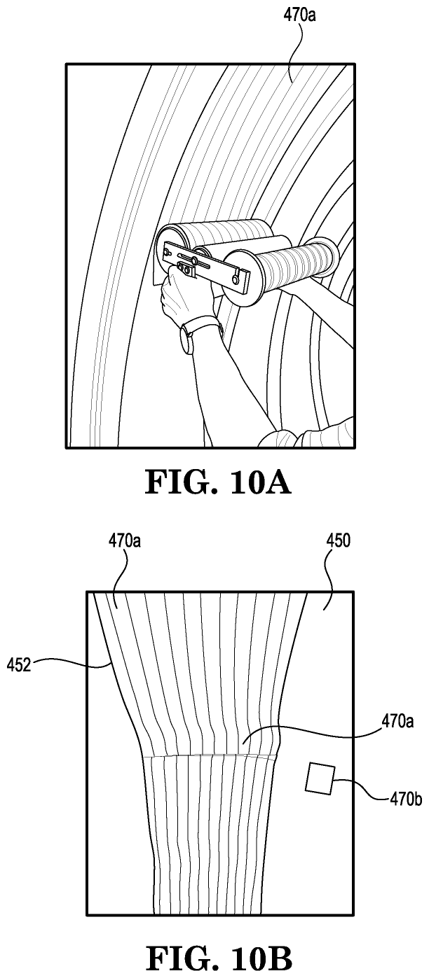

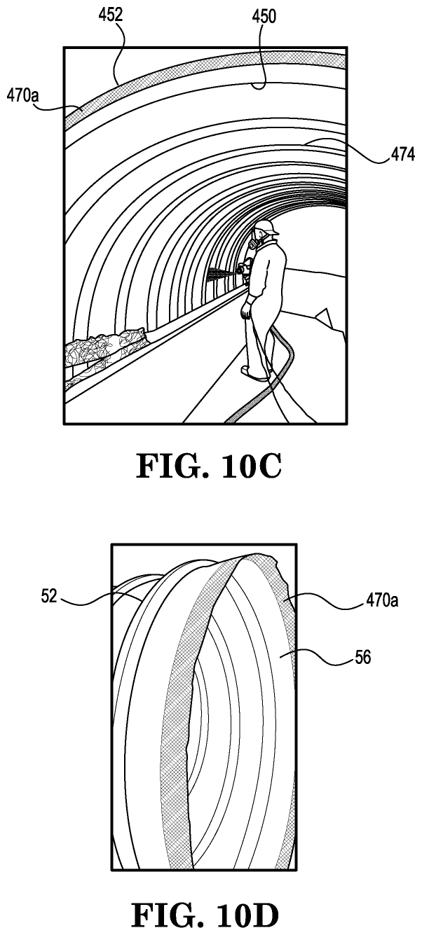

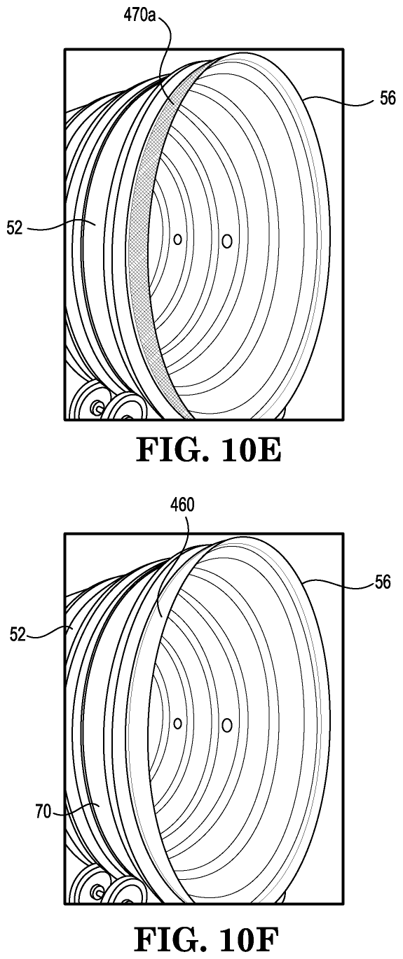

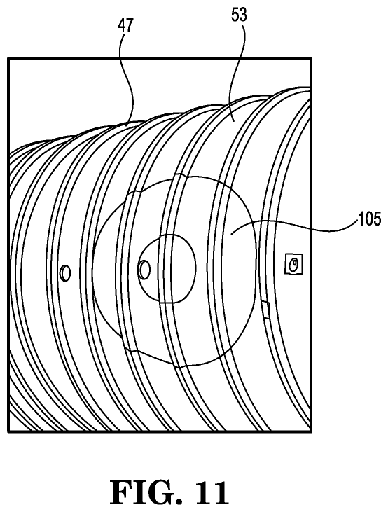

Further, for example, in one or more other embodiments, the underground storage tank 50 may be female molded to provide integral ribs (e.g., ribs 66) to enhance strength and resist detachment of ribs from walls of the underground storage tank under application of compressive forces. For example, in one embodiment, the FRP underground storage tank 50 (e.g., a composite material storage tank made of a polymer matrix reinforced with fibers, such as glass fibers) may be prepared from female-molded plastic resin and chopped fiber, which is sprayed onto the interior of a female mold (e.g., FIGS. 10A-10C). The resin may be applied with a catalyst, as it is sprayed together with the chopped fiber, to create a strong, relatively stiff, water impermeable wall. For example, the resin may include an epoxy, vinylester, or polyester resin, or combinations thereof. Further, for example, in one or more embodiments, the resin may include vinyl esters, isophthalic polyesters, polyurethanes, and combinations thereof. Further, for example, resins may include polyethylene, polyvinylchloride, polyepoxide, or combinations thereof. Further, for example, the fibers may include glass fibers, carbon fibers, aramid fibers, basalt fibers, or combinations thereof. FRP components to be bonded to FRP tank surfaces may be formed of similar materials, such as composite material made of a polymer matrix reinforced with fibers, including fibers in the form of chopped, fiber mat, woven roving, etc.).

For example, in a female mold process, the ribs are “molded in” to the tank form, in either a closed or open design, with accurate placement of the ribs being premised on the mold, which can be designed to mold tolerances. In other words, for example, a female mold itself may include structure for forming ribs 66 (e.g., circumferential ribs) between wall portions (e.g., circumferential smooth portions) where necessary, so that they become part of an integral underground storage tank structure. Information on the method of comminuting the glass fibers, as well as application of the fibers and resin to the interior of the female mold, is set forth in U.S. Pat. No. 5,645,231.

The underground storage tank 50 as shown in FIG. 2 may be formed using multiple female mold portions (e.g., such as mold portions shown partially in FIGS. 10A-10C). For example, the underground storage tank 50 may be formed using a first female mold portion to provide a first tank portion or half 52 and a second female mold portion to provide a second tank portion or half 54. Dashed circumferential line 57 about the perimeter of the cylindrical shell body 51 is provided to diagrammatically represent the seam 60 (e.g., the center seam) between the first tank half 52 and second tank half 54.

Each of the first tank half 52 and the second tank half 54 are generally symmetrical in the tank 50 of FIG. 2 although such symmetry is not required (e.g., any size or shape of tank portions may be assembled to form a tank for use in containing material). As shown in FIG. 2, first tank half 52 includes a first cylindrical shell 64 terminating at a dome shaped end 65 to provide an exterior surface 70 and ribs 66 upon which one or more components may be mounted. Second tank half 54 includes a second cylindrical shell 62 terminating at a dome shaped end 63 to provide an exterior surface 72 and ribs 66 upon which one or more components may be mounted. Prior to joining the first tank half 52 with the second tank half 54, each of the first tank half 52 and second tank half 54 include an open end 56, 58, respectively. After female mold portions corresponding to the first and second tank halves 52, 54 are removed resulting in the first and second tank halves 52, 54, and after such halves 52, 54 are fully cured, the first and second tank halves 52, 54 may be adjoined using FRP about the center seam 60 to couple the open ends 56, 58 forming cylindrical shell body 51 extending from the first dome end 48 to the second dome end 49 (e.g., resin and mat FRP layers may be layed up about the entire perimeter along the seam 60 to seal the seam 60 and adjoin the tank halves). Although the cylindrical shell body 51 is shown as a cylinder having the same diameter along its entire length, one will recognize that the diameter may change along the length.

As shown and described with reference to FIG. 2, the underground storage tank 50 includes the tank body 47 including the cylindrical shell body 51 and ribs 66 formed on or as a part thereof. The exterior surface 53 of the underground storage tank 50 may include non-planar portions of the tank body 47 including one or more portions of the cylindrical shell body 51, the ribs 66, the dome shaped ends 63, 65, etc. of the tank 50. Further, as shown in FIG. 2, various components are mounted on at least a non-planar portion of the exterior surface 53 of the tank body 47. In one or more embodiments, the one or more components each include a mounting surface (not shown in FIG. 2) configured to mate with at least the non-planar portion of the exterior surface 53 of the tank body 47 on which it is mounted.

For example, as shown in FIG. 2, manway apparatus 84 and monitoring reservoir apparatus 80 are shown as being mounted on at least a non-planar portion of the exterior surface 53 of the tank body 47 including a portion of the cylindrical shell body 51 as well as a portion of a rib 66. Further, for example, pipe fittings 88, lift lug assemblies 94, and guide lug assemblies 90 are shown as being mounted on at least a non-planar portion of the exterior surface 53 of the tank body 47 including a portion of the cylindrical shell body 51. An adhesive at an interface between the mounting surface of the component being mounted and the non-planar portion of the exterior surface 53 of the tank body 47 forms a structural bond at the adhesive interface between the mounting surface of the component and the non-planar portion of the exterior surface 53 of the tank body 47.

One will recognize that various components may be mounted according to the present disclosure. For example, in one or more embodiments, openings for various components, such as pipe fittings, manway apparatus, collars, monitoring reservoir apparatus, and the like, may be introduced through the tank body 47, as necessary. The components may then be mounted on the exterior surface 53 of the tank body 47 at defined locations corresponding to such openings. For example, one or more mounted components may extend in a direction away from the exterior surface 53 of the tank body 47 (e.g., such as the manway apparatus 84 about a manway opening). Further, for example, one or more mounted components may include a portion that extends through at least the exterior surface 53 of the tank body 47 (e.g., a pipe fitting 88 mounted through an opening).

In one or more embodiments, the mounted components may include a cylindrically shaped body extending from a first end (e.g., a first open end) to be mounted adjacent the exterior surface 53 to a second end further from the exterior surface 53 when mounted using the adhesive. For example, in one or more embodiments, such a component to be mounted may include a flange (e.g., flange 122 of manway apparatus 84 or flange 162 of monitoring reservoir apparatus 80) at the first end thereof (e.g., the flange being integrally formed with the cylindrical shaped body), wherein the flange provides a mounting surface about a perimeter of the first end (e.g., a first open end such as for a manway opening). The mounting surface of the flange is formed to mate with the non-planar portion of the exterior surface 53 upon which it is to be mounted (e.g., if the non-planar portion of the exterior surface 53 includes a portion of at least one rib 66, then the flange is configured to mate with the portion of the rib 66). For example, such cylindrically shaped components may include manway apparatus, collar apparatus (e.g., such as collars having substantially the same cylindrical body and flange as the manway apparatus 84 and thus not separately identified in the figures), monitoring reservoir apparatus, vent fittings, etc. In one or more embodiments, the flange may include a nonrectangular shape (e.g., a pentagonal shape, a hexagonal shape, an octagonal shape, etc.).

Further, for example, one or more components to be mounted using the adhesive may include components that have a non-planar (e.g., curved or bent) base to be mounted adjacent the exterior surface 53 and one or more other structural features that project from the base (e.g., lift lugs, guide lugs, etc.). For example, the curved or bent base may provide a mounting surface formed to mate with the non-planar portion of the exterior surface 53 upon which it is to be mounted. For example, such a component including a curved or bent base may include a lift lug assembly, a guide lug assembly, etc. In one or more embodiments, the curved or bent base configured to mate with the non-planar portion of the exterior surface 53 may include a nonrectangular curved shape (e.g., a pentagonal shape, a hexagonal shape, an octagonal shape, etc.).

Yet further, for example, one or more components to be mounted may include a coupling structure that may extend through the exterior surface 53 of the tank body 47 when mounted by the adhesive. For example, the coupling structure may extend from a first end (e.g., a first open end) to a second end (e.g., a second open end) and include a flange at a location between the first and second end. For example, the flange may provide a mounting surface formed to mate with the non-planar portion of the exterior surface 53 upon which it is to be mounted. For example, such a component including a coupling structure may include a single pipe fitting, a duplex or dual pipefitting, a triplex or triple pipe fitting, etc. In one or more embodiments, the flange may include a nonrectangular shape (e.g., a pentagonal shape, a hexagonal shape, an octagonal shape, etc.).

The mounting surfaces provided by the components to be mounted may be formed such that a tolerance of the mounting surface dimensions relative to corresponding dimensions of the non-planar portion of the exterior surface 53 is within 80 mil (that is, 80 mils or less, wherein a “mil” is a unit of length equal to 0.0254 millimeters or 0.001 inches). In one or more other embodiments, a tolerance of the mounting surface dimensions relative to corresponding dimensions of the non-planar portion of the exterior surface 53 may be within 30 mil. However, in some other circumstances, larger tolerances may be tolerated and a structural bond between the mounting surface and the exterior surface 53 may still be formed (e.g., may be within 40 mil, 50 mil, 60 mil, 70 mil). At least in one embodiment, mounting surfaces provided by the components to be mounted may be formed such that a tolerance of the mounting surface dimensions relative to corresponding dimensions of the non-planar portion of the exterior surface 53 is preferably within 40 mil.

Further, for example, the adhesive used to mount the various components and form a structural bond between the mounting surface thereof and a portion of the exterior surface 53 includes an ambient curing adhesive (e.g., cures at room temperature). In one or more embodiments, the adhesive may include an acrylic adhesive. For example, in one or more embodiments, the acrylic adhesive may include an acrylate adhesive, a methacrylate adhesive, or combinations thereof. In certain embodiments, the acrylic adhesive may include acrylate esters (e.g., ethyl acrylate), methacrylate esters (e.g., methyl methacrylate (MMA)), or combinations thereof. Further, in one or more embodiments, the acrylic adhesive may be and/or include a methyl methacrylate (MMA) adhesive (e.g., such as SG300 series (e.g., SG300-05, SG300-15, and SG300-40) adhesive available from SciGrip Smarter Adhesive Solutions, Durham, N.C., USA). Still further, in one or more embodiments, a non-epoxy adhesive may be used to mount one or more of the various components.

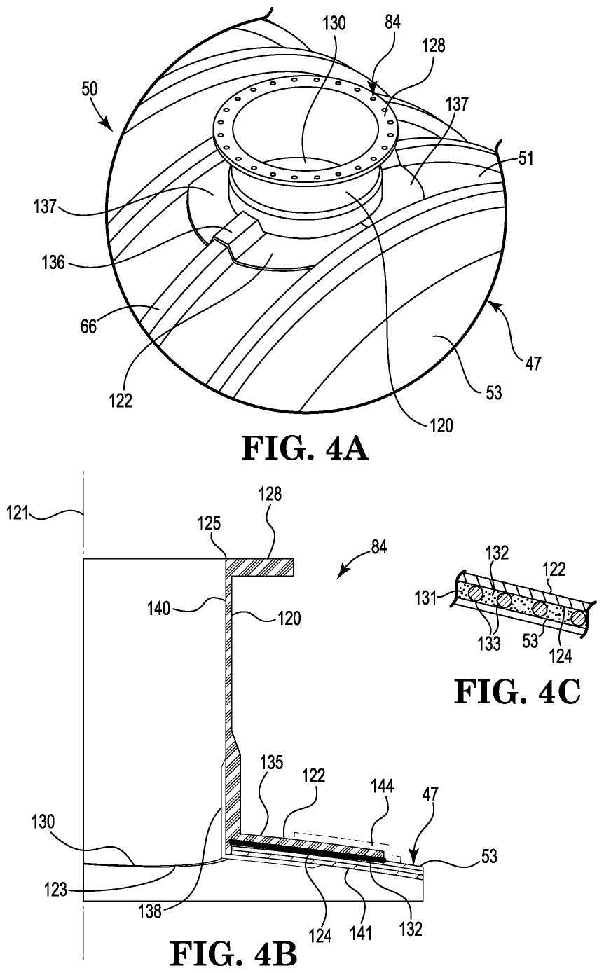

In one or more embodiments, the adhesive used to mount the various components and form a structural bond between the mounting surface thereof and a portion of the exterior surface 53 may include rigid particles sized to control the minimum thickness of adhesive layer. For example, such rigid particles may include glass beads or any other particles suitable to provide suitable spacing between the mounting surface and the portion of the exterior surface 53 to maintain the minimum thickness of the adhesive layer during curing (e.g., keep the pressure applied when mounting from expelling an undesirable amount of the adhesive from the mounting surface/exterior surface interface). In one or more embodiments, the rigid particles (e.g., glass beads) may be of one or more diameters within the range of 30 to 80 mils. FIG. 4C illustrates an exemplary adhesive 131 forming an adhesive interface 132 between a mounting surface 124 of a component and the non-planar portion of the exterior surface 53 of the tank body. As shown in this view, the adhesive interface 132 has a thickness at least partially controlled by rigid particles 133 in the adhesive 131 having a diameter (or effective diameter if the particles are not spherical) of 30 mil to 80 mil.

Further, the rigid particles may be uniformly dispersed in adhesive or manually added on an applied adhesive layer to control the minimum thickness of adhesive layer. In one embodiment, for example, to install bent lift lugs, glass beads may be required at the edges and the center of the plate where the adhesive layer has the minimum thickness.

Yet further, in one or more embodiments, one or more surfactants may be used as sizing on the rigid particles (e.g., one or more surfactants applied to, or otherwise incorporated into glass beads) to increase the adhesion between the rigid particles within the adhesive. For example, any surfactant (e.g., such as hydro oxide surfactant) may be used as sizing on rigid particles. By providing an increased adhesion between the rigid particles and adhesive, a failure is less likely to occur at the interface of rigid particles and adhesive (e.g., the adhesive layer will not fail due to lack of bonding between the rigid particles and the adhesive) and the loads will completely transfer to the substrate (e.g., the exterior surface of the tank body). The surfactant creates chemical bond with the adhesive on one side thereof, and on the other side of the surfactant, it is mechanically connected to rigid particle. Therefore, there exists a stronger bond between the adhesive and the rigid particles.

Still further, in one or more embodiments, solid particles may be dispersed in the adhesive to enhance the toughness of the adhesive layer. For example, such solid particles may include micro- and/or nano-sized carbon particles (e.g., spherical carbon black, carbon nanotubes, graphine nanoplatelets, etc.). For example, such solid particles may be uniformly dispersed in the adhesive using high shear or three roll mill methods prior to application. Various different combinations of the rigid particles (e.g., glass beads) and solid particles (e.g., micro- and/or nano-sized carbon particles) may be used.

In one or more embodiments, the adhesive used to mount various components forms a structural bond at the adhesive interface between the mounting surface of the component being mounted and the non-planar portion of the exterior surface 53 of the tank body 47 that is capable of withstanding at least 180 pounds per square inch (1240 kilopascals) of peel pressure applied thereto. Further, in one or more embodiments, the adhesive used to mount various components forms a structural bond at the adhesive interface between the mounting surface of the component being mounted and the non-planar portion of the exterior surface 53 of the tank body 47 that is capable of withstanding 2000 foot pounds (2712 newton meters) of bending moment applied thereto.

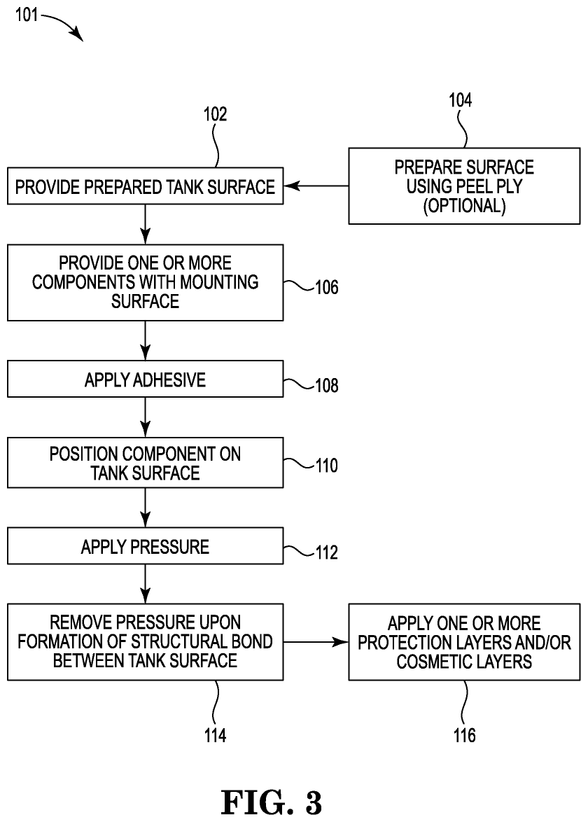

FIG. 3 shows a method 101 of mounting components on an underground storage tank. In one or more embodiments, the method 101 includes providing a prepared tank surface (block 102) upon which one or more components may be mounted. For example, in one or more embodiments, a portion of the exterior surface 53 corresponding to the mounting surface of a component to be mounted (e.g., corresponding to the shape of a flange on a manway apparatus or a base of a lift lug assembly) may be cleaned, abraded (e.g., such as by grinding), sandblasted, or otherwise prepared for suitable formation of a structural bond between the mounting surface of the component and the corresponding portion of the exterior surface 53. For example, a portion of the exterior surface 53 may be cleaned to reduce any amount of lubricant thereon and then a component to be mounted is positioned on the cleaned surface without grinding or otherwise physically abrading the portion of the exterior surface 53. As an example, the portion of the exterior surface 53 corresponding to the mounting surface of a flange of the manway apparatus 84 may be cleaned for mounting of the manway apparatus 84 without grinding being required to abrade the surface on which it is mounted.

In one or more embodiments, the exterior surface 53 of the tank body 47 may be prepared by using a removable fabric, such as a releasable peel ply material (e.g., which is a non-smooth fabric at least on one side thereof for use in providing a roughened tank surface portion as described herein) as indicated at block 104. For example, in one or more embodiments, a removable fabric (e.g., a releasable fabric) may be adhered (e.g., using a tackifier or other like adhesive, such as NuTack-Blu available from Polynt Composites USA, Inc. (Carpentersville, Ill. USA), or catalyzed resin used in manufacturing the tank) to one or more locations on the interior surface of a female mold portion (e.g., used to form at least a portion of tank body 47) corresponding to the non-planar portion of the exterior surface 53 of the tank body 47 on which a component is to be mounted (e.g., corresponding to or encompassing the shape of a flange on a manway apparatus or a base of a lift lug assembly).

In forming the tank body 47, one or more layers of fiber and resin are applied on the interior surface of the female mold portion and over the removable fabric in formation of the tank body 47 and the exterior surface 53 thereof. After at least partial curing of the portion of the tank body 47 being formed, it may be removed from the female mold portion. The removable fabric is removed with the portion of the tank body when the portion of the tank body 47 is removed from the female mold portion (e.g., tank body 47 having at least a portion of the exterior surface 53 thereof covered by removable fabric). For example, a circular removable fabric portion 105 corresponding to the configuration of the mounting surface of a flange 122 of a manway apparatus 84 is shown in FIG. 11 after removal of the portion of the tank body 47 from a female mold.

The removable fabric (e.g., peel ply 105) may then be removed from the exterior surface 53 of the portion of the tank body resulting in the non-planar portion of the exterior surface 53 upon which the component is to be mounted being roughened as compared to other portions of the exterior surface 53 of the tank body 47. By providing a roughened surface for mounting of a component using adhesive in this manner, the need to grind and abrade the tank body 47 to provide a roughened surface may be eliminated, or at least reduced. In such a manner, particulate in the manufacturing region resulting from such grinding is accordingly reduced. One will recognize that the portion of the exterior surface 53 corresponding to the mounting surface of any of the components to be mounted thereon may be prepared using such a removable fabric (e.g., peel ply 105). Such removable fabrics are available from Airtech Advance Material Group (Airtech International, Inc. of Huntington Beach, Calif., USA), under the trade designation Econostitch G peel ply. In addition to providing a roughened portion of the exterior surface 53 of the tank body, other embodiments may provide the component to be mounted with a roughened mounting surface upon which the adhesive may be applied.

As shown in FIG. 3, following the preparation of the tank surface (e.g., exterior surface 53), one or more components to be mounted on the prepared surface are provided (block 106). For example, one or more components such as those described herein or shown in FIG. 2 may be provided for mounting on the exterior surface 53. Each of the one or more components to be mounted includes a mounting surface configured to mate with a non-planar portion of the exterior surface 53 on which it is to be mounted. For example, the flange 122 of a manway apparatus 84 (e.g., or similar flange on a collar) or the flange 162 of a monitoring reservoir 80 is configured to mate with a corresponding portion of the exterior surface 53 (e.g., the flange may include curved portions to mate with the cylindrical shell body 51 of the tank body 47 and/or include portions thereof which mate with portions of a rib 66).

To proceed with mounting the component on the prepared surface, an adhesive is applied (block 108) to at least one of the mounting surface of the component or the portion of the exterior surface 53 of the tank body corresponding to the configuration of the mounting surface (e.g., a portion of the exterior surface 53 corresponding to the shape of the flange 122 of the manway apparatus 84 when such a component is being mounted). At least in one or more embodiments, the adhesive is only applied to the mounting surface of the component. Any suitable method for applying such an adhesive may be used. For example, application processes such as with use of manual adhesive applicators or dispensers, pneumatic applicators or dispensers, etc. may be used to apply one or more layers of adhesive as desired.

The amount of adhesive applied and the pattern of application will vary depending upon the shape of the bonding surface, the gap between the portion of the tank and the mounting surface of the component being mounted thereon, the maximum applied load, and also the minimum required adhesive thickness of the adhesive used. In one or more embodiments, for example, when the adhesive used is an MMA adhesive, then the minimum thickness of the adhesive should be in the range of 30 mil to 80 mil after application of pressure. At least in one embodiment, the thickness is about 40 mil. Such minimum thickness may be controlled with use of the rigid particles (e.g., glass beads) in the adhesive having a diameter in the range of 30 mil to 80 mil.

Beads of the adhesive (e.g., which may include glass beads or some other rigid particles) dispensed on, for example, the mounting surface of the component being mounted may be provided on the mounting surface in a pattern such that after applying pressure to the component (e.g., pressing the component to the tank surface, the adhesive covers all of the mounting surface and fills all the gaps between the tank surface and the mounting surface of the component (e.g., no voids exist at the interface). In one or more embodiments, the rigid particles (e.g., glass beads) of a particular diameter (e.g., in the range of 30 mil to 80 mil) are provided in the adhesive (e.g., either provided as part of the adhesive prior to application or provided to the adhesive after application) sufficient to result in a minimum adhesive thickness of equal to or greater than 30 mil after applying pressure between the component and the tank surface and when the adhesive is curing. In one or more embodiments, the rigid particles (e.g., glass beads) of a particular diameter (e.g., in the range of 30 mil to 80 mil) are provided (e.g., either provided as part of the adhesive prior to application or provided to the adhesive after application) sufficient to result in a maximum adhesive thickness of equal to or less than 80 mil after applying pressure between the component and the tank surface and when the adhesive is curing.

The component to be mounted is then positioned on the prepared portion of the exterior surface 53 (block 110). After positioning the component, a pressure is applied (block 112) to maintain the position of the component on the non-planar portion of the exterior surface 53 of the tank body 47 as the adhesive is cured to form an adhesive interface between the mounting surface of the component and the non-planar portion of the exterior surface 53 of the tank body 47. Any process and/or structure may be used for applying such pressure. For example, such pressure may be applied by merely taping the component onto the tank body 47, may be applied by use of a fixture configured to clamp the component onto the tank body 47 (e.g., a suction clamp), may be applied manually, may be applied by a machine pressing against the component, etc. Further, for example, in one or more embodiments, a pressure distribution is applied evenly across the adhesive interface as the adhesive is cured.

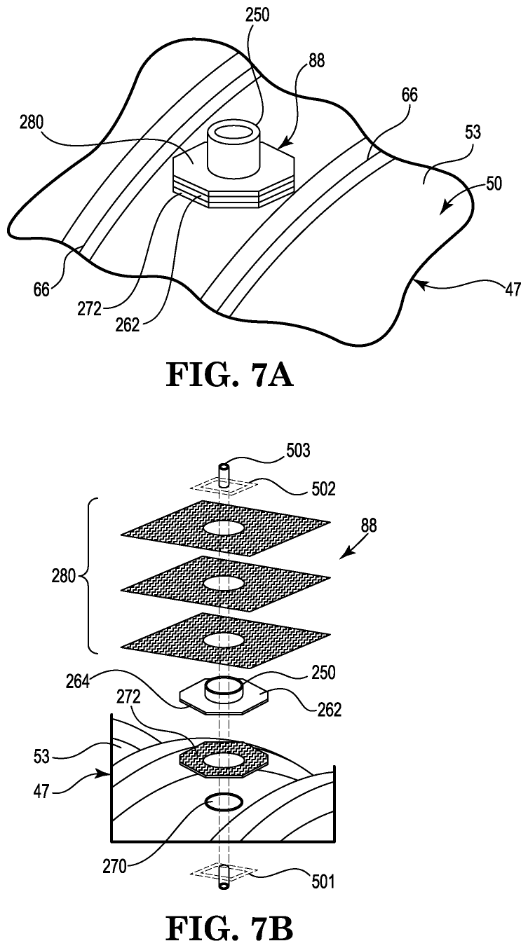

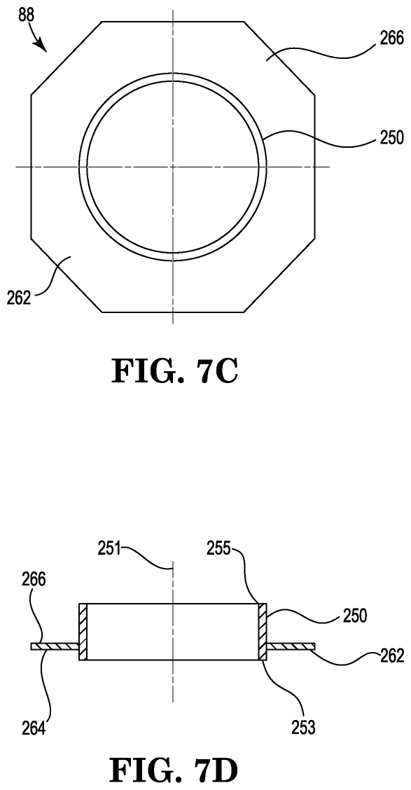

In one or more embodiments, for example, a clamp is used to mount a component having an opening extending therethrough (e.g., such as a plate fitting, a pipe fitting, a manway apparatus, etc.), wherein the clamp includes an elongate element extending through the opening of the component for applying such pressure. For example, as shown in FIG. 7B, the clamp may include a plate 501 on the inside of the tank body 47 and a plate 502 on the outside of the tank body 47 with an elongated element 503 connecting the two plates. The component (e.g., a flange of the pipe fitting 88) may be caused to be engaged against the tank body 47 (e.g., the distance between the two plates being adjustable such that pressure may be applied and adjusted to force the flange against the tank body 47).

After formation of the structural bond at the adhesive interface between the mounting surface of the component and the non-planar portion of the exterior surface 53 of the tank body 47 (e.g., upon curing of the adhesive), the pressure may be removed (block 114). With the component mounted on the exterior surface 53 of the tank body 47, one or more other optional processes may be performed to provide one or more layers associated with the mounted component (block 116).

For example, in one or more embodiments, one or more protection layers to prevent fluids from contact with the adhesive may be formed. For example, as described herein, when mounting a manway apparatus 84, one or more layers of protective material may be applied to one or more locations proximate the adhesive interface used to mount the manway apparatus 84 to prevent exposure of the adhesive interface to a fluid (e.g., liquid or vapor, such as brine, petroleum vapors, etc.). However, such protection layers do not provide the structural attachment of the component to the tank but merely provide a fluid barrier function. The structural bond of the component to the tank body 47 is completely provided with use of the adhesive.

Further, in one or more embodiments, one or more cosmetic FRP layers may be formed to create a visually appealing product. For example, as described herein, one or more cosmetic FRP layers may be applied on a portion of the exterior surface 53 of the tank body 47 adjacent the mounting surface of the component and continuously on a surface of the component opposite the mounting surface thereof. Such layers are only for cosmetic purposes only and do not provide structural attachment of the component to the tank body 47. Rather, only the adhesive is used to form the structural bond between the component and the exterior surface 53 of the tank body 47.

In one or more embodiments, the thickness of the layers of FRP used as protection layers and/or cosmetic layers is ⅛ inch or less. In one or more embodiments, for example, such a thickness may be provided by less than 4 layers of mat impregnated with resin.

Further, in one or more embodiments, the use of adhesives to mount components on an exterior surface 53 of tank body 47, may provide the ability to more easily remove a mounted component (e.g., when the location of the component needs to be changed). For example, at least in one embodiment, heat may be used to remove the component from the exterior surface 53 of the tank body 47. For example, an electrical heater may be configured to apply heat to a guide lug assembly or a lift lug assembly (e.g., a metal assembly, such as a steel base portion of a lift lug assembly or guide lug assembly) to change the composition of the adhesive such that the component may be released from the exterior surface 53 of the tank body 47. Temperatures in the range of 220 degrees Farenheit (104 degrees Celsius) to 250 degrees F. (121 degrees C.) may be beneficially used for such purposes. Upon removal, the same or a different component may be positioned at the same or a different location.

FIGS. 4A and 4B show a perspective view of one exemplary embodiment of a manway apparatus 84 mounted on an exterior surface 53 of the underground storage tank 50 and a more detailed cross-sectional view of a portion thereof, respectively. The manway apparatus 84 includes a cylindrical body portion 120 extending along axis 121 from a first end 123 to a second end 125 (e.g., wherein the cylindrical wall thickness is greater at the first end 123 relative to the second end 125). A mounting flange 122 extends outwardly from the first end 123 of the cylindrical body portion 120 and in a direction away from axis 121 (e.g., the mounting flange being integrally preformed with the cylindrical body portion before positioning the manway apparatus 84 on the tank body 47). The mounting flange 122 includes a lower mounting surface 124 and an upper surface 135 opposite the lower mounting surface 124 (e.g., facing in an opposite direction).

The lower mounting surface 124 is configured to mate with the exterior surface 53 of the cylindrical shell body 51 and structure forming rib 66. In other words, the mounting surface 124 includes shell portions 137 to be placed adjacent the exterior surface 53 of the cylindrical shell body 51 (e.g., the mounting surface 124 having a curve to match the cylindrical nature of the exterior surface in such locations; as shown by the curved or angled nature of the flange 122 in FIG. 4B) and flange portions 136 to be placed adjacent the exterior surface 53 of rib 66 (e.g., mounting surface 124 having a shape to match the shape of rib 66 in such locations is shown in FIG. 4A).

The manway apparatus 84 further includes coupling flange 128 that extends outwardly from the second end 125 of the cylindrical body portion 120 and in a direction away from axis 121. The coupling flange 128 includes a plurality of holes such as for mounting the manhole cover and/or any other desirable structure.

In one or more embodiments, the manway apparatus 84 is a preformed FRP component. For example, the manway apparatus 84 may be formed from multiple layers of FRP material provided relative to a mold. For example, the thickness of the multiple layers of FRP material (e.g., forming the flange or the cylindrical body portion of the manway apparatus) may be greater than ¼ inch to provide a structural component that may be effectively mounted. For example, multiple layers in the range of 9 to 12 layers of FRP may be used to provide such a thickness. However, the manway apparatus 84 may be formed in any configuration but must include structure for mounting the manway apparatus using an adhesive as described herein. For example, the flange 122 of the manway apparatus 84 (e.g., which may be formed integrally with the cylindrical body portion) provides a suitable mounting surface 124 that may be structurally bonded to exterior surface 53 of tank body 47 using adhesive as described herein.

As shown in FIGS. 4A-4B, the manway apparatus 84 is mounted about an opening 130 created in the tank body 47. Adhesive, such as those described herein, is used to form a structural bond at the adhesive interface 132 between the mounting surface 124 of the manway apparatus 84 and the non-planar portion of the exterior surface 53 of the tank body 47 (e.g., a rib portion and a portion of the shell body). The structural bond of the adhesive interface 132 is about the entire perimeter of the flange 122 which provides a seal about the entire perimeter of the flange 122 between the flange 122 and the exterior surface 53 of the tank body 47 (e.g., the seal being provided by the adhesive over a radial distance of about at least 6 inches). In one or more embodiments, the flange has a radial width of 6 inches or more, and in one or more embodiments, the FRP flange has a thickness of greater than ¼ inch.

Further, as shown in FIG. 4B, for example, in one or more embodiments, one or more FRP protection layers 138 to prevent fluids from contact with the adhesive interface 132 may be formed. As shown therein, the one or more protection layers 138 are formed (e.g., using resin and mat) along an inner surface 140 of the cylindrical body portion 120 at the first end 123 and continually therefrom along an inner surface 141 of tank body 47. Thus, any portion of the adhesive interface 132 proximate the first end 123 of the manway apparatus 84 is prevented from being exposed to a fluid (e.g., liquid or vapor, such as brine, petroleum vapors, etc.) in the tank 50. Such protection layers may be used with the mounting of any component described herein.

Further, in one or more embodiments, one or more cosmetic FRP layers 144 may be formed to create a visually appealing product. For example, as described herein, one or more cosmetic FRP layers 144 may be applied (e.g., using resin and mat) on a portion of the exterior surface 53 of the tank body 47 adjacent the mounting surface 124 and continuously on the upper surface 135 of the flange 122. Such layers 144 are clearly optional and only for cosmetic purposes as only the adhesive interface 132 is provided to structurally bond the mounting surface 122 of the manway apparatus 84 to the exterior surface 53 of the tank body 47. Such cosmetic FRP layers 144 may be provided about the entire perimeter of flange 122. Such cosmetic layers may be used with the mounting of any component described herein. FIG. 4C shows an enlarged portion of FIG. 4B.

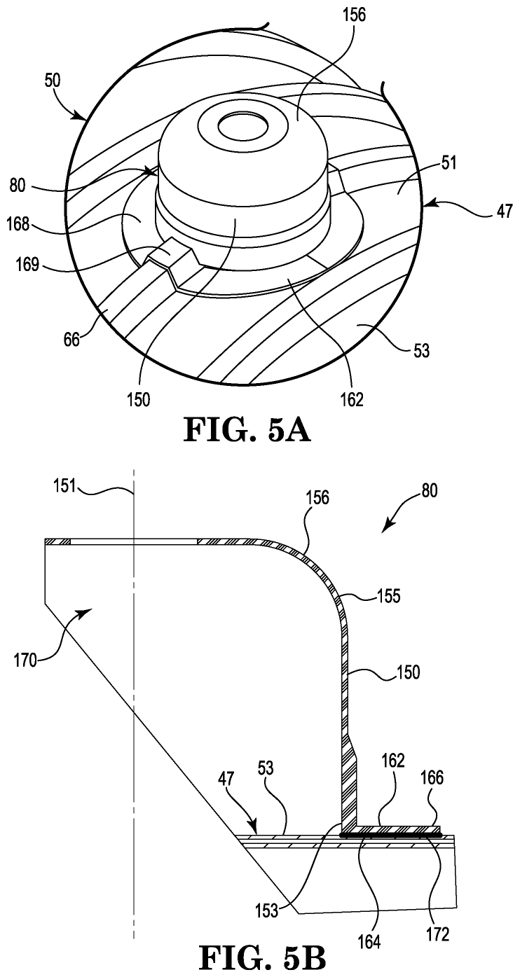

FIGS. 5A and 5B show a perspective view of one exemplary embodiment of a monitoring reservoir 80 mounted on an exterior surface 53 of a tank 50 and a more detailed cross-sectional view of a portion thereof, respectively. The monitoring reservoir 80 includes a cylindrical body portion 150 extending along axis 151 from a first end 153 to a second end 155 where the second end 155 is terminated by a cap portion 156 (e.g., generally extending orthogonal to axis 151). The cylindrical wall thickness of the body portion 150 is greater at the first end 153 relative to the second end 155. The cap portion 156 may be configured such that a pipe fitting may be mounted thereon using adhesive in a manner like other pipe fitting components as described herein.

A mounting flange 162 extends outwardly from the first end 153 of the cylindrical body portion 150 and in a direction away from axis 151. The mounting flange 162 includes a lower mounting surface 164 and an upper surface 166 opposite the lower mounting surface 164 (e.g., facing in an opposite direction). The lower mounting surface 164 is configured to mate with the exterior surface 53 of the cylindrical shell body 51 and structure forming rib 66. In other words, the mounting surface 164 includes shell portions 168 to be placed adjacent the exterior surface 53 of the cylindrical shell body 51 (e.g., the mounting surface 164 having a curve to match the cylindrical nature of the exterior surface in such locations) and rib portions 169 to be placed adjacent the exterior surface 53 of rib 66 (e.g., mounting surface 164 having a shape to match the shape of rib 66 in such locations as shown in FIG. 5A).

In one or more embodiments, the monitoring reservoir apparatus 80 is a preformed FRP component. For example, it may be formed from multiple layers of FRP material provided relative to a mold. For example, the thickness of the multiple layers of FRP material (e.g., forming the flange or the cylindrical body portion of the monitoring reservoir apparatus) may be greater than 6.4 mm to provide a structural component that may be effectively mounted. For example, multiple layers in the range of 9 to 12 layers of FRP may be used to provide such a thickness. However, the monitoring reservoir apparatus 80 may be formed in any configuration but must include structure for mounting the monitoring reservoir apparatus using an adhesive as described herein. For example, the flange 162 of the monitoring reservoir apparatus 80 (e.g., which may be formed integrally with the cylindrical body portion) provides a suitable mounting surface 164 that may be structurally bonded to exterior surface 53 of tank body 47 using adhesive as described herein.

As shown in FIGS. 5A-5B, the monitoring reservoir apparatus 80 is mounted adjacent tank body 47 such that the interior 170 thereof may be put in communication with fluid in an annular space between walls of the tank body 47 for monitoring purposes. Adhesive, such as those described herein, is used to form a structural bond at the adhesive interface 172 between the mounting surface 164 of the monitoring reservoir apparatus 80 and the non-planar portion of the exterior surface 53 of the tank body 47 (e.g., a rib portion and a portion of the shell body) in a manner similar to the bond formed at the adhesive interface 132 between the mounting surface 124 and the exterior surface 53 as shown in FIG. 4C. The structural bond of the adhesive interface 172 is about the entire perimeter of the flange 162 which provides a seal about the entire perimeter of the flange 162 between the flange 162 and the exterior surface 53 of the tank body 47. The flange 162 may be formed with similar characteristics as the manway apparatus flange.

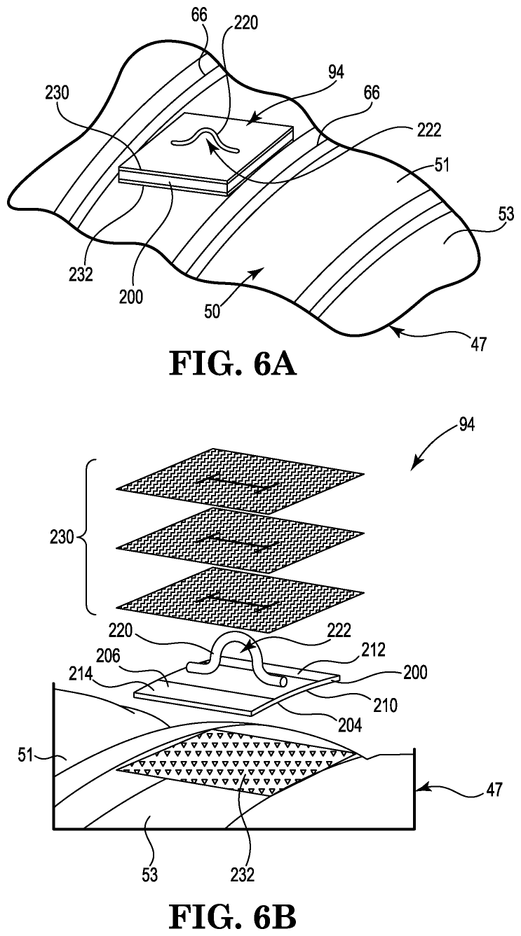

FIGS. 6A and 6B show a perspective view of one exemplary embodiment of a lift lug assembly 94 mounted on an exterior surface 53 of a storage tank 50 and an exploded view thereof, respectively (e.g., the perspective view being shown with only FRP layers 230 formed on the top surface of the assembly). In FIGS. 6A-6B (as well as in other figures herein, the various layer stacks (e.g., the base portion 200, FRP layers 230, and adhesive interface 232 in FIG. 6A) are shown enlarged in thickness for clarity. Moreover, the adhesive interface layer may be shown independent and separated (see adhesive interface 232 in FIG. 6B) from the tank body for purposes of explanation. The lift lug assembly 94 includes a base portion 200 (e.g., configured in polygon shape, for example, which may be rectangular or non-rectangular) that includes a lower mounting surface 204 and an upper surface 206 opposite the lower mounting surface 204 (e.g., facing in an opposite direction). The lower mounting surface 204 is configured to mate with the exterior surface 53 of the cylindrical shell body 51. In other words, the mounting surface 204 is non-planar (e.g., curved or bent shape) to match the cylindrical nature of the exterior surface 53 of the cylindrical shell body 51. As shown in FIGS. 6A and 6B, the base portion 200 may be bent and formed of multiple adjacent sections suitable to mate with the cylindrical nature of the exterior surface 53 upon which it is mounted. For example, such sections may include a middle section 210 and one or more adjacent sections 212, 214 provided at an angle relative to and extending from the middle section 210 (e.g., terminating at edges).

Further, the lift lug assembly 94 includes a lift lug portion 220 extending from the upper surface 206 of the base portion 200. The lift lug portion 220 is configured with the base portion 200 to form an opening 222 through which one or more hooks, cables, or other lifting apparatus may be inserted for use in at least lifting the tank 50 (tank body 47) in a vertical direction.

In one or more embodiments, the lift lug assembly 94 may be formed of metal, such as by the welding of lift lug portion 220 on base portion 200. The lift lug assembly 94 may be formed in any configuration but must include a suitable mounting surface for mounting the lift lug assembly 94 using an adhesive as described herein. For example, the base portion 200 must include a suitable mounting surface 204 that may be structurally bonded to exterior surface 53 of tank body 47 using adhesive as described herein (e.g., the mounting surface dimensions must be within a certain dimensional tolerance relative to the exterior surface). For example, the mounting surface dimensions must be within 4 millimeters maximum dimensional tolerance relative to the exterior surface at the bends (i.e., the interfaces between the middle section 210 and one or more adjacent sections 212, 214) and in the range of about zero to 40 mil dimensional tolerance at the two edges and center of the middle section 210.

As shown in FIGS. 6A-6B, the lift lug assembly 94 is mounted adjacent a portion of the exterior surface 53 of tank body 47. Adhesive, such as those described herein, is used to form a structural bond at the adhesive interface 232 between the mounting surface 204 of the lift lug assembly 94 and the non-planar portion of the exterior surface 53 of the tank body 47. Multiple layers 230 of mat and resin may be applied to the upper surface 206 to cover all of the exposed metal of base portion 200 of the lift lug assembly 94; with the lift lug portion 222 extending therethrough.

Guide lug assembly 90 may be mounted in substantially the same manner as the lift lug assembly 94. Therefore, details regarding the mounting thereof will not be provided herein.

FIGS. 7A and 7B show a perspective view of one exemplary embodiment of a single pipe fitting 88 mounted on an exterior surface 53 of a storage tank 50 and an exploded view thereof, respectively (e.g., the perspective view being shown with only FRP layers 280 formed on the top surface of the assembly). FIGS. 7C and 7D show a top view and a side section view, respectively, of one exemplary embodiment of the single pipe fitting 88 shown in FIGS. 7A and 7B. The pipe fitting 88 includes a cylindrical body portion 250 extending along axis 251 from a first end 253 to a second end 255. A mounting flange 262 extends outwardly from the cylindrical body portion 250 and in a direction away from axis 251 at a location somewhere between the first end 253 and the second in 255. At least in one embodiment, the mounting flange 262 is located closer to one end than the other. The mounting flange 262 includes a lower mounting surface 264 and an upper surface 266 opposite the lower mounting surface 264 (e.g., facing in an opposite direction).

The lower mounting surface 264 is configured to mate with the exterior surface 53 of the cylindrical shell body 51. In other words, the mounting surface 264 to be placed adjacent the exterior surface 53 of the cylindrical shell body 51 may be curved to match the cylindrical nature of the exterior surface 53). In one or more embodiments, the flange may include a nonrectangular shape (e.g., a pentagonal shape, a hexagonal shape, an octagonal shape, etc.). For example, as shown in FIG. 7C, the flange shape is an octagon.

In one or more embodiments, the pipe fitting 88 may be formed of metal, such as by the welding of the cylindrical body portion 250 to the flange 262. The pipe fitting 88 may be formed in any number of configurations, but must include structure for mounting the pipe fitting using an adhesive as described herein. For example, the flange 262 of the pipe fitting 88 provides a suitable mounting surface 264 that may be structurally bonded to exterior surface 53 of tank body 47 using adhesive as described herein.

As shown in FIGS. 7A-7B, the pipe fitting 88 is mounted about an opening 270 created in the tank body 47 with a portion of the first end 253 extending therethrough. Adhesive, such as those described herein, is used to form a structural bond at the adhesive interface 272 (exploded from the tank body in FIG. 7B) between the mounting surface 264 of the pipe fitting 88 and the non-planar portion of the exterior surface 53 of the tank body 47 (e.g., a portion of the shell body). Multiple layers 280 of mat and resin may be applied to the upper surface 206 to cover all of the exposed metal of the flange 262.

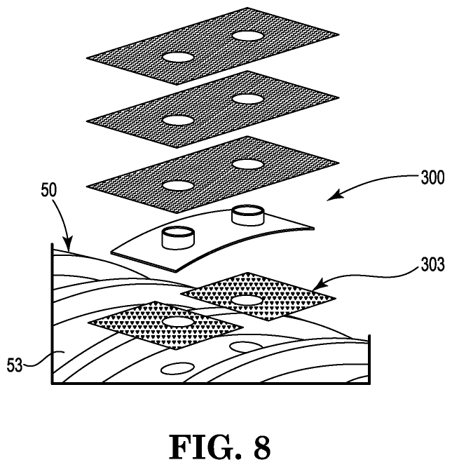

FIG. 8 shows an exploded perspective view of one exemplary embodiment of a duplex or double pipe fitting 300 that may be mounted on an exterior surface 53 of a storage tank 50 using an adhesive interface 303. The duplex pipe fitting 300 may be mounted in substantially the same manner as the single pipe fitting 88. Therefore, details regarding the mounting thereof will not be provided herein.

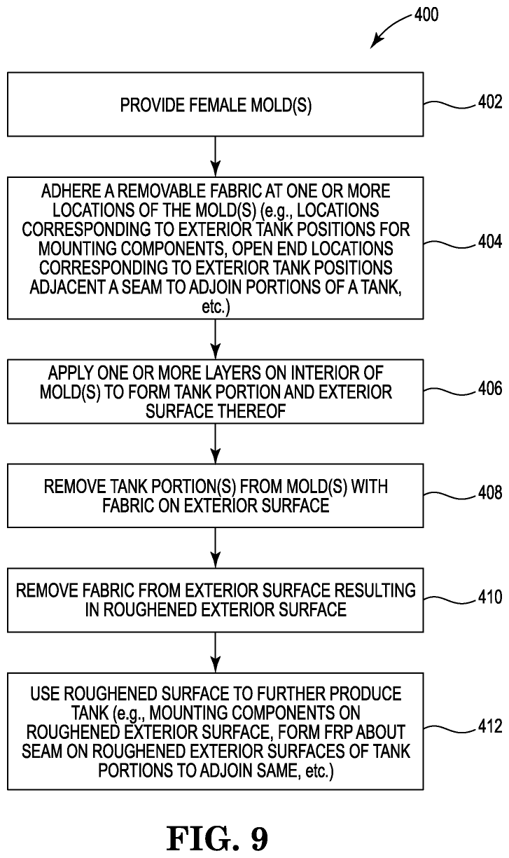

FIG. 9 is an exemplary block diagram of one or more embodiments of a method 400 that uses removable fabric to roughen surfaces for use in the formation of storage tanks. FIGS. 10A-10F provide multiple diagrams for use in describing one or more embodiments of the method 400 shown generally in FIG. 9 (e.g., methods for the formation of tanks that include roughened exterior surfaces for the mounting of components using adhesives, methods for the formation of tanks that include roughened exterior surfaces for use in adjoining tank portions using FRP layers to seal a seam about a perimeter of the tank, etc.).

As shown in FIG. 9, in one or more embodiments, the method 400 of manufacturing an underground storage tank includes providing one or more female molds (e.g., each having an interior surface to be used to form a tank portion or an entire tank) (block 402). A removable fabric (e.g., a releasable fabric such as peel ply) is adhered (e.g., in a manner as previously described herein) at one or more locations on the one or more female molds (block 404). For example, the one or more locations may correspond to exterior tank positions for mounting components (e.g., components such as lift lug assemblies, guide lug assemblies, collars, manway apparatus, monitoring reservoir apparatus, etc.). Further, for example, the one or more locations may include open end locations on multiple female molds corresponding to exterior tank positions adjacent a seam to adjoin tank portions formed using the multiple female molds (e.g., perimeter portions of the exterior surfaces adjacent the first open end of the first portion of the tank body and the second open end of the second portion of the tank body).

Thereafter, one or more layers of material (e.g., FRP, annular layers between FRP layers, etc.) may be applied on the interior of the one or more female molds (and over any removable fabric) to form one or more tank portions (i.e., including exterior surfaces thereof) (block 406). The one or more tank portions (portions of the tank body) may be removed from the one or more female molds with the removable fabric on the exterior surface thereof (block 408). The removable fabric may then be removed from the exterior surface of the one or more tank portions resulting in roughened exterior surfaces (compared to other portions of the exterior surface) corresponding to the locations where the removable fabric was applied (block 410).

Further, as shown in FIG. 9, the roughened surfaces formed using the removable fabric may then be used to further produce the tank (block 412). For example, one or more components may be mounted on roughened surfaces corresponding to mounting surfaces of the one or more components using an adhesive, such as described herein (e.g., components such as lift lug assemblies, guide lug assemblies, collars, manway apparatus, monitoring reservoir apparatus, etc.). Further, for example, a center seam may be sealed to adjoin tank portions formed using multiple female molds by applying FRP layers to roughened perimeter portions of the exterior surfaces adjacent a first open end of a first portion of a tank body and a second open end of a second portion of a tank body, such as described herein.

FIGS. 10A-10F provide multiple diagrams for use in describing the use of roughened surfaces (e.g., roughened using a removable fabric, such as a releasable peel ply fabric) in the adjoining of tank portions formed using multiple female molds. References to FIG. 2 shall be made which show the center seam 60 between two tank halves 52, 54. However, it shall be recognized that adjoining tank portions may include adjoining any number of different types of tank portions. For example, a dome shaped end portion like dome shaped end 63 which may only include a single open end may be adjoined to a cylindrical shell portion like cylindrical shell body 62 which may include two open ends, two cylindrical shell portions with each having to open ends may be adjoined, etc. In other words, for example, any tank portions having similarly sized open ends may be adjoined at a seam thereof using FRP layers on roughened surfaces created using removable fabric, such as peel ply.

For example, in one or more embodiments of the method for using such roughened surfaces, a first female mold portion having an interior surface to form at least a first portion of a tank body (e.g., tank half 52) having an exterior surface 53 and a first open end 56 may be provided (see, for example, the female mold portion 450 in FIGS. 10B-10C). The first female mold portion 450 includes a first open end 452 corresponding to the first open end 56 of the first portion 52 of the tank body. In one or more embodiments, the first female mold portion 452 may include a first cylindrical portion being open on at least one end 452 or a first dome portion being open on one end 452 depending upon what type of tank portion is being formed by the first female mold portion 450.

Likewise, a second female mold portion (not shown, but like female mold portion 450) having an interior surface to form at least a second portion of the tank body (e.g., tank half 54) having an exterior surface 53 and having a second open end 58 is provided. The second female mold portion (not shown, but like female mold portion 450) includes a second open end (not shown, but like open end 452) corresponding to the second open end 58 of the second portion 54 of the tank body. In one or more embodiments, the second female mold portion (not shown, but like female mold portion 450) may include a second cylindrical portion being open on at least one end or a second dome portion being open on one end depending upon what type of tank portion is being formed by the second female mold portion.

The first open end 56 of the first portion 52 of the tank body and the second open end 58 of the second portion 54 of the tank body are configured to be adjoined by forming FRP about seam 60 (e.g., around perimeter portions of the exterior surfaces 53 adjacent the first open end 56 of the first portion 52 of the tank body and the second open end 58 of the second portion 54 of the tank body). In furtherance of forming the FRP about the seam 60, a removable fabric (e.g., a releasable fabric such as peel ply 470) is adhered along a perimeter at the first open end 452 on the interior surface of the first female mold portion 450 and along a perimeter at the second open end (not shown, but like open end 452) on the interior surface of the second female mold portion (not shown, but like female mold portion 452) corresponding to the perimeter portions 460, 462 (see also FIG. 2) of the exterior surface 53 adjacent the first open end 56 of the first portion 52 of the tank body and the second open end 58 of the second portion 54 of the tank body.

For example, FIG. 10A-10B shows the application of peel ply 470a on the interior surface of a female tank mold for formation of a roughened surface for use in sealing a center seam 60 using a roller type dispensing apparatus. Further, application of peel ply 470b as shown in FIG. 10B may be used for use in roughening surfaces for mounting of components (e.g., peel ply 470b may be used in the roughening of surfaces for a component like a lift lug assembly 94 or a guide lug assembly 90). One will recognize that any type of dispensing apparatus, whether manual or automated, may be used to provide removable fabric at the locations desired on the interior surface of a female tank mold. Further, such removable fabric may be applied by hand. Further, FIG. 10B shows the layer of peel ply 470a applied along a perimeter at an open end (such as open end 452) on an interior surface of a female mold portion (such as female mold portion 450), for example, as may correspond to one of the perimeter portions 460, 462 of the exterior surface 53 adjacent the first open end 56 of the first portion 52 of the tank body and the second open end 58 of the second portion 54 of the tank body.

In one or more embodiments, at least one or more layers of FRP 474 (e.g., resin and fiber) may be applied on the interior surface of the first female mold portion 452 and over the removable fabric 470a-b in formation of the first portion 52 of the tank body and the exterior surface 70 thereof as shown in FIG. 10C. Further, at least one or more layers of FRP 474 (e.g., resin and fiber) may be applied on the interior surface of the second female mold portion and over the removable fabric 470a-b in formation of the second portion 54 of the tank body and the exterior surface 72 thereof.

Upon at least partial curing, and as shown in FIG. 10D, the first portion 52 of the tank body may be removed from the first female mold portion 452 (i.e., the removable fabric 470a (and 470b) is removed with the first portion 52 of the tank body when removed from the first female mold 452). Likewise, the second portion 54 of the tank body 54 may be removed from the second female mold portion (i.e., the removable fabric 470a-b is removed with the second portion 54 of the tank body when removed from the second female mold).

As shown in FIG. 10E, a portion of the removable fabric 470a at the perimeter of the open ends 56, 58 of the portions 52, 54 may be trimmed as desired. Thereafter, as shown in FIG. 10F, removing the removable fabric 470a from the exterior surface 70 of the first portion 52 of the tank body results in the perimeter portion 460 of the exterior surface 70 adjacent the first open end 56 of the first portion 52 of the tank body being roughened as compared to other portions of the exterior surface 70 of the tank body (e.g., such as for use in sealing the center seam 60 with FRP layers). Likewise, removing the removable fabric 470a from the exterior surface 72 of the second portion 54 of the tank body results in the perimeter portion 462 of the exterior surface 72 adjacent the second open end 58 of the second portion 54 of the tank body being roughened as compared to other portions of the exterior surface 72 of the tank body 54. Further, removing the removable fabric 470b from the exterior surface 70 of the first portion 52 of the tank body results in the exterior surface 70 corresponding to the portion of the tank body previously covered by removable fabric 470b being roughened as compared to other portions of the exterior surface 70 of the tank body 52 (e.g., such as for use in mounting components thereon using adhesive as described herein).

The exterior surfaces 460, 462 adjacent the first open end 56 of the first portion 52 of the tank body and the second open end 58 of the second portion 54 of the tank body may be adjoined using FRP layers about the seam 60 (e.g., around the roughened perimeter portions 460, 462 of the exterior surfaces 70, 72 adjacent the first open end 56 of the first portion 52 of the tank body and the second open end 58 of the second portion 54 of the tank body. For example, multiple layers of FRP material may be applied about the seam. In one or more embodiments, each of such multiple layers may include the application of mat and resin about the center seam (e.g., around to the perimeter of the tank body 47). For example, the FRP seal about seam which adjoins the first and second tank halves 52 and 54 is formed around perimeter portions of the exterior surfaces adjacent the open end 56 of the first cylindrical portion and the open end 58 of the second cylindrical portion.

The complete disclosures of the patents, patent documents, and any other publications cited in the Background, the Summary, the Detailed Description of Exemplary Embodiments, and elsewhere herein are incorporated by reference in their entirety as if each were individually incorporated.

Exemplary embodiments of the present disclosure are described above. Those skilled in the art will recognize that many embodiments are possible within the scope of the invention. Other variations, modifications, and combinations of the various components and methods described herein can certainly be made and still fall within the scope of the disclosure. Thus, the disclosure is limited only by the following claims and equivalents thereto.

1. A method of manufacturing a storage tank, the method comprising:
providing a tank body comprising an exterior surface formed of fiber reinforced plastic;
providing a component to be mounted on at least a non-planar portion of the exterior surface of the tank body, wherein the component comprises a mounting surface configured to mate with at least the non-planar portion of the exterior surface of the tank body;
applying an adhesive to at least one of the mounting surface of the component and the non-planar portion of the exterior surface of the tank body;
positioning the component on the non-planar portion of the exterior surface of the tank body;
applying a pressure to maintain the position of the component on the non-planar portion of the exterior surface of the tank body as the adhesive is cured to form an adhesive interface between the mounting surface of the component and the non-planar portion of the exterior surface of the tank body; and
removing the pressure upon curing of the adhesive and formation of a structural bond at the adhesive interface between the mounting surface of the component and the non-planar portion of the exterior surface of the tank body.

2. The method of claim 1, wherein the component to be mounted comprises at least one of a manway apparatus, a collar apparatus, and monitoring reservoir apparatus, wherein the component to be mounted comprises a flange at a first end thereof, and further wherein the flange comprises the mounting surface about a perimeter of the first end.

3. The method of claim 2, wherein the non-planar portion of the exterior surface of the tank body comprises a portion of at least one rib, and further wherein the flange comprises a mounting surface configured to mate with the portion of the at least one rib.

4. The method of claim 2, wherein the flange comprising the mounting surface is formed such that a tolerance of mounting surface dimensions relative to corresponding dimensions of the non-planar portion of the exterior surface is within 80 mil.

5. The method of claim 1, wherein the component to be mounted comprises at least one of a lift lug configured to be engaged by an apparatus used in lifting the tank body in at least a vertical direction, a guide lug configured to be engaged by an apparatus used in guiding the tank body in at least horizontal direction, and a pipe fitting.

6. The method of claim 5, wherein the component to be mounted comprises the pipe fitting, and further wherein the component comprises an opening, wherein applying the pressure to maintain the position of the component on the non-planar portion of the exterior surface of the tank body as the adhesive is cured comprises holding the component on the non-planar portion of the exterior surface of the tank body using a clamp comprising an elongate element extending through the opening of the pipe fitting.

7. The method of claim 5, wherein the mounting surface configured to mate with at least the non-planar portion of the exterior surface of the tank body comprises a non-rectangular curved or bent mounting surface shape.

8.-13. (canceled)

14. The method of claim 1, wherein the method further comprises applying one or more layers of fiber reinforced material on a portion of the exterior surface adjacent the mounting surface of the component and continuously on a surface of the component opposite the mounting surface, wherein the one or more layers has a thickness of ⅛ inch or less.

15.-17. (canceled)

18. The method of claim 17, wherein applying the adhesive comprises using an adhesive comprising methyl methacrylate (MMA).

19. The method of claim 1, wherein applying the adhesive comprises using an adhesive comprising rigid particles having a diameter in the range of 30 mil to 80 mil.

20. (canceled)

21. The method of claim 1, wherein applying the adhesive comprises using an adhesive comprising rigid particles sized using a surfactant.

22. The method of claim 1, wherein applying the adhesive comprises using an adhesive comprising micro- and/or nano-sized carbon particles.

23. (canceled)

24. The method of claim 1, wherein providing the tank body comprising the exterior surface comprises:
providing a female mold portion having an interior surface to form at least a portion of the tank body, wherein the female mold portion comprises at least one of a cylindrical portion and a dome portion;
adhering a removable fabric at one or more locations on the interior surface of the female mold portion corresponding to the non-planar portion of the exterior surface of the tank body;
applying one or more layers of resin on the interior surface of female mold portion and over the removable fabric in formation of the exterior surface of the tank body;
removing the at least a portion of the tank body from the female mold portion, wherein the removable fabric is removed with the at least a portion of the tank body when removed from the female mold portion; and
removing the removable fabric from the exterior surface of the at least a portion of the tank body resulting in the non-planar portion of the exterior surface upon which the component is mounted being roughened as compared to other portions of the exterior surface of the tank body.

25. A storage tank comprising:
a tank body comprising an exterior surface formed of fiber reinforced plastic;
a component mounted on at least a non-planar portion of the exterior surface, wherein the component comprises a mounting surface configured to mate with at least the non-planar portion of the exterior surface of the tank body; and
an adhesive at an adhesive interface between the mounting surface and the non-planar portion of the exterior surface of the tank body, the adhesive forming a structural bond at the adhesive interface between the mounting surface of the component and the non-planar portion of the exterior surface of the tank body.

26. The tank of claim 25, wherein the component to be mounted comprises at least one of a manway apparatus, a collar apparatus, and monitoring reservoir apparatus, wherein the component to be mounted comprises a flange at a first end thereof, and further wherein the flange comprises the mounting surface about a perimeter of the first end.

27. The tank of claim 26, wherein the non-planar portion of the exterior surface of the tank body comprises a portion of at least one rib, and further wherein the flange comprises a mounting surface configured to mate with the portion of the at least one rib.

28. The tank of claim 26, wherein the flange comprising the mounting surface is formed such that a tolerance of mounting surface dimensions relative to corresponding dimensions of the non-planar portion of the exterior surface is within 80 mil.

29. The tank of claim 25, wherein the component to be mounted comprises at least one of a lift lug configured to be engaged by an apparatus used in lifting the tank body in at least a vertical direction, a guide lug configured to be engaged by an apparatus used in guiding the tank body in at least horizontal direction, and a pipe fitting.

30.-31. (canceled)

32. The tank of claim 25, wherein the component comprises a portion that extends through at least the exterior surface of the tank body.

33. The tank of claim 25, wherein the tank further comprises a protective material at one or more locations proximate the adhesive interface to prevent exposure of the adhesive interface to fluid.

34. The tank of claim 25, wherein the tank further comprises one or more layers of fiber reinforced plastic material on a portion of the exterior surface adjacent the mounting surface of the component and continuously on a surface of the component opposite the mounting surface, wherein the one or more layers have a thickness of ⅛ inch or less.

35.-36. (canceled)

37. The tank of claim 36, wherein the adhesive comprises methyl methacrylate (MMA).

38. The tank of claim 25, wherein the adhesive comprises rigid particles having a diameter in the range of 30 mil to 80 mil.

39.-43. (canceled)
